(19) United States
(12) Patent Application Publication
(10) Pub. No.: US 2012/0007735 A1
(43) Pub. Date: Jan. 12, 2012

(54) Wearable Device and System for Tracking a Person's Location

(75) Inventor: Peter D. Rhyins, Prosper, TX (US)

(73) Assignee: PARAGON GPS, INC., Dallas, TX (US)

(21) Appl. No.: 12/831,968

(22) Filed: Jul. 7, 2010

(51) Int. Cl. G08B 1/08

(52) U.S. Cl. 340/539.13

(57) ABSTRACT

A wearable personal tracking device that can communicate over a cellular network. The device includes a wrist mounted part, having a wristband and a clasp which holds the wristband on to the wrist of a user. The housing holds a position detecting part which detects the position of a user who is wearing said wrist mounted part, and a cellular transceiving part which communicates information including said information via the cellular network, e.g., via G3 cellular internet connectivity. The device automatically produces an alarm based on a position of the user when in a monitoring mode.

### BACKGROUND

Numerous prior attempts of location systems have been provided in the prior art.

U.S. Pat. No. 6,362,778 B2 describes a system able to locate and track a user retaining a portable locator unit using numerous location technologies including Global Positioning Satellite (GPS) System and the generation of a beacon for use in pinpointing the location of the locator unit and thus the user.

U.S. Pat. No. 5,043,736 describes a portable location unit useful both as a cellular telephone and portable GPS that provides latitude and longitude information remotely to a base unit display. The system includes a small hand held receiver that receives signals from a satellite GPS and timing and computing circuits to provide location information signals. The hand held unit also includes a modem and transmitter to a cellular telephone network which is connected to the base unit computational system and display. The location of an individual or object can thus be determined at the remote station through the use of the cellular telephone network.

U.S. Pat. No. 5,289,163 describes a child position monitoring device monitors the position of a child by detecting the signal strength of a radio frequency carrier from a transmitter attached to the child. If the signal of the radio frequency carrier is too weak, it means that the child is too far away from the adult who has the child position monitoring device. When this happens, the adult is informed that the child has wandered too far away through the use of an audio tone or through the use of vibrations coming from the device. Once the adult is notified that the child is too far away, the device also has a locating display for indicating the relative direction of the child with respect to the adult. The display uses eight LED's arranged around an emblem used to represent the position of the adult. The LED which lights up indicates the relative direction of the child.

### SUMMARY

The present invention relates to a wearable location tracking device that is worn on a users wrist, and a system that can track the device. In an embodiment, this tracking uses a combination of a GPS positioning satellite system beacon and modern G3 Cellular network position tracking capabilities. An embodiment describes G3 cellular internet connectivity to provide the two-way communication of the watch assembly.

Embodiments incorporate methods to relay images and voice distress signals in the event of an alarm condition from the wearer of the device.

### BRIEF DESCRIPTION OF THE DRAWINGS

In the Drawings:

FIG. 1A-1C shows the mechanical structure of the GPS and cellular watch according to an embodiment;

FIG. 2 shows a flow diagram of the information according to an embodiment;

FIG. 3 shows a communication flow diagram;

FIG. 4 shows a schematic of a circuit diagram of the electronic structure within the GPS locator watch.

### DETAILED DESCRIPTION

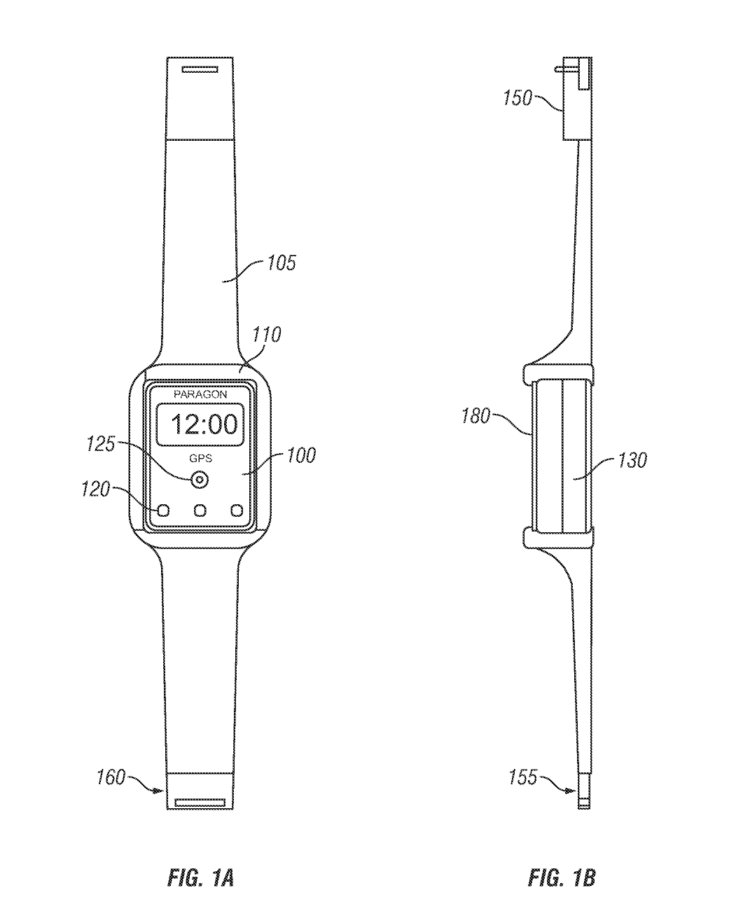

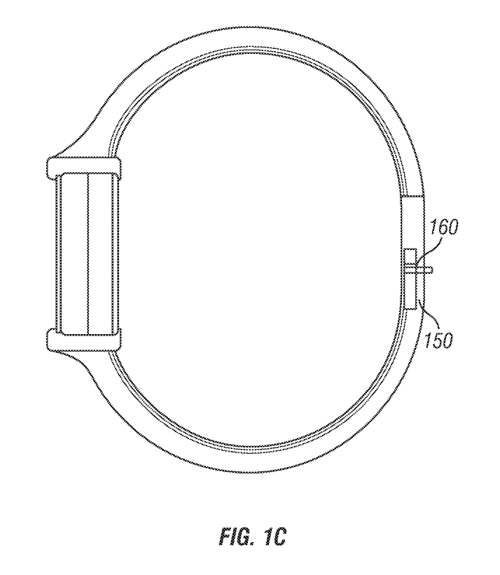

A wearable device that is worn on a person's wrist and the device having an appearance of a conventional wrist watch is used according to an embodiment. FIGS. 1A-1C shows the structure of the watch. The watch includes, as conventional, a bezel 100 and band 105. The bezel covers a case 110 that includes the electronic components therein. The electronic components operate as described herein to relay the wearer's position to a remote monitoring device or station as described in detail herein. For example, in one embodiment the system may incorporates a cellular telephone transmitter and receiver using G3 Internet protocol, as well as GPS receiver and transmitter. The device can transmit data that represents the location of the watch, and hence its wearer at any time. This can be done in real-time as seen by the remote monitoring device.

The watch face also includes settings buttons 120 that allows setting of different features such as the time. The watch face may also house the opening of a camera 125.

FIG. 1B shows a view of the watch from its side view, showing the case 110 holding the electronics module, and a battery 130. The clasp for the watch is formed by an electronic lock 150 that locks to a corresponding locking part 155. The lock includes a latch portion 160 that locks to the electronic lock 150 to maintain the device on for example a child's arm. FIG. 1C shows the device as latched, where the latch device 160 extends upward into a cavity within the electronic lock portion 150.

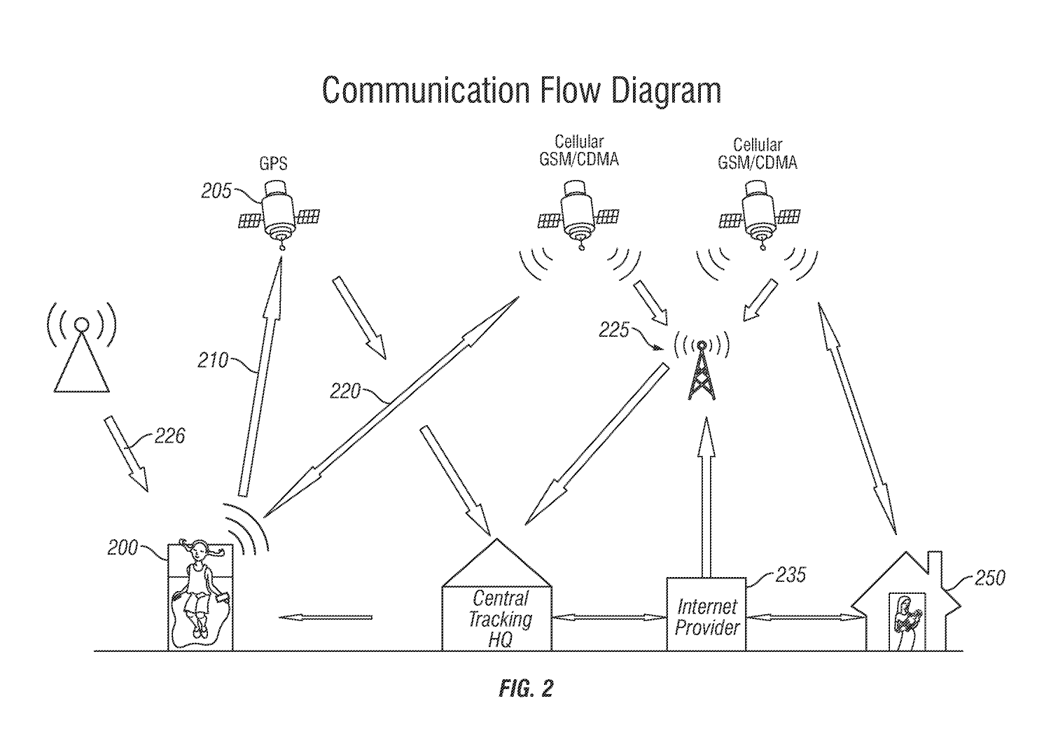

The position of the device and wearer can be determined as shown in the communication flow diagram of FIG. 2. In a first technique, a person's location is determined via GPS data 210 from a GPS Satellite 205 sent to the locator watch on the person being monitored 200. A second way of determining the location is by tracking the device with G3 mobile communications and triangulation from multiple cellular, PCS, or mobile phone service transmitting towers 225, 226. Either or both of these can be used together, in order to provide a more thorough and complete coverage of the device and wearer's location. For example, this may provide improved location capability in areas such as within buildings where GPS satellite coverage is not sufficient to provide useful location information, whereas the G3 mobile communication triangulation will be used to determine the wearer's position.

A host cellular telephone device or computer 250 that is connected to the Internet 255 can remotely control and/or communicate with the locating device over any Internet connection.

The locating device contains an electronic lock mechanism 150/155/160 that is activated by the host 250, e.g., via monitoring cellular telephone device or computer. The electronic lock is automatically activated when the clasp that retains the device to the wearers wrist is tampered with or attempted to be removed from the wearer, or if the device or if the wearer's position moves beyond a pre-determined area designated by the monitoring device. When the electronic lock is activated, a signal is sent to the monitoring device through the Internet and/or cellular service text messaging.

The monitoring also causes a situation where camera 125 is activated to relay pictures to the monitoring device when the electronic lock is activated. This information can be helpful to determine the current emergency conditions, and to provide additional data as to the state of the wearer and why the electronic lock was activated.

The locating wristwatch device has a conventional clasp on the watchband that can be adjusted to fit different sizes of wearers.

The watchband clasp contains a switch that transmits an electronic signal to the electronic lock mechanism. The electronic lock, once activated, latches to prevent removal of the locating device from the wearer's wrist. If the clasp is forced open at that time, it causes an alarm to be established and sent over the internet connection to the monitoring host 250.

The watchband clasp can also be used as a ‘Panic Button’ by the wearer to send a distress signal to the monitoring host 250, since it automatically causes an alarm.

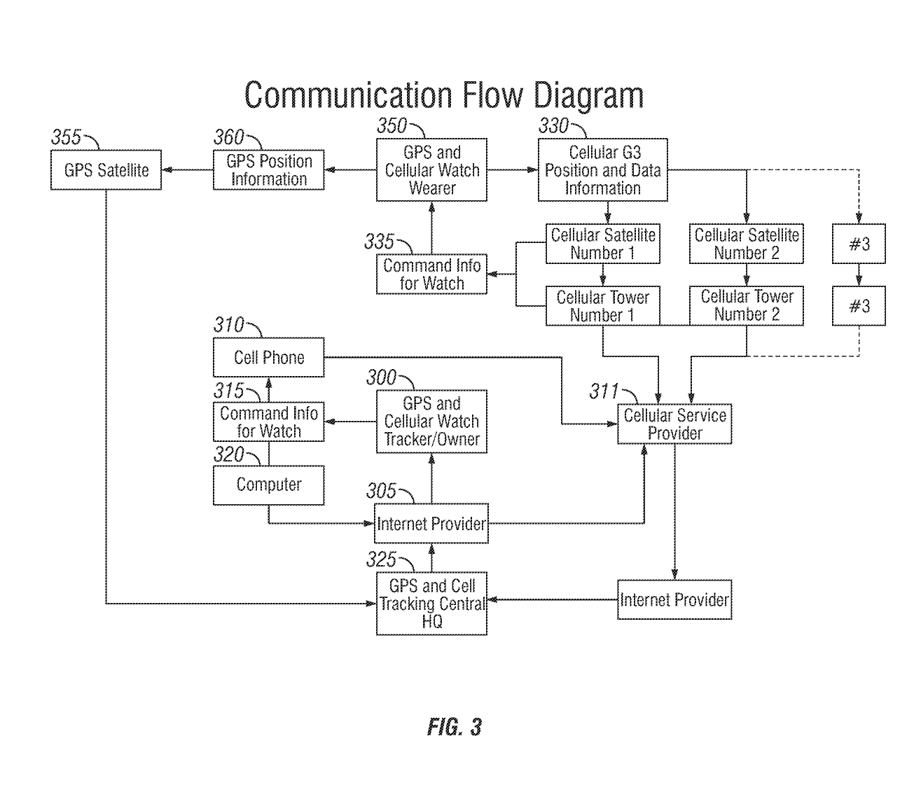

FIG. 3 illustrates a communication flow diagram of an embodiment. The tracker/owner is shown as 300, and the watch itself is shown as 350. The tracker can provide command information for the watch at 315. This can be sent via cell phone at 310, through the cellular service provider. It can alternatively be sent via computer at 320 through an Internet provider 305. The Internet provider may also send the information through the cellular service provider, with the final destination being the watch itself at 350. The cellular satellites are shown generically as 330, and their position can be triangulated via the cell tracking central headquarters 325. Any of this information can provide command information 335 which is sent to the watch 350.

A GPS satellite shown as 355 can also provide GPS position information 360 that can alternatively be used for determining the location of the watch. This can operate as described herein.

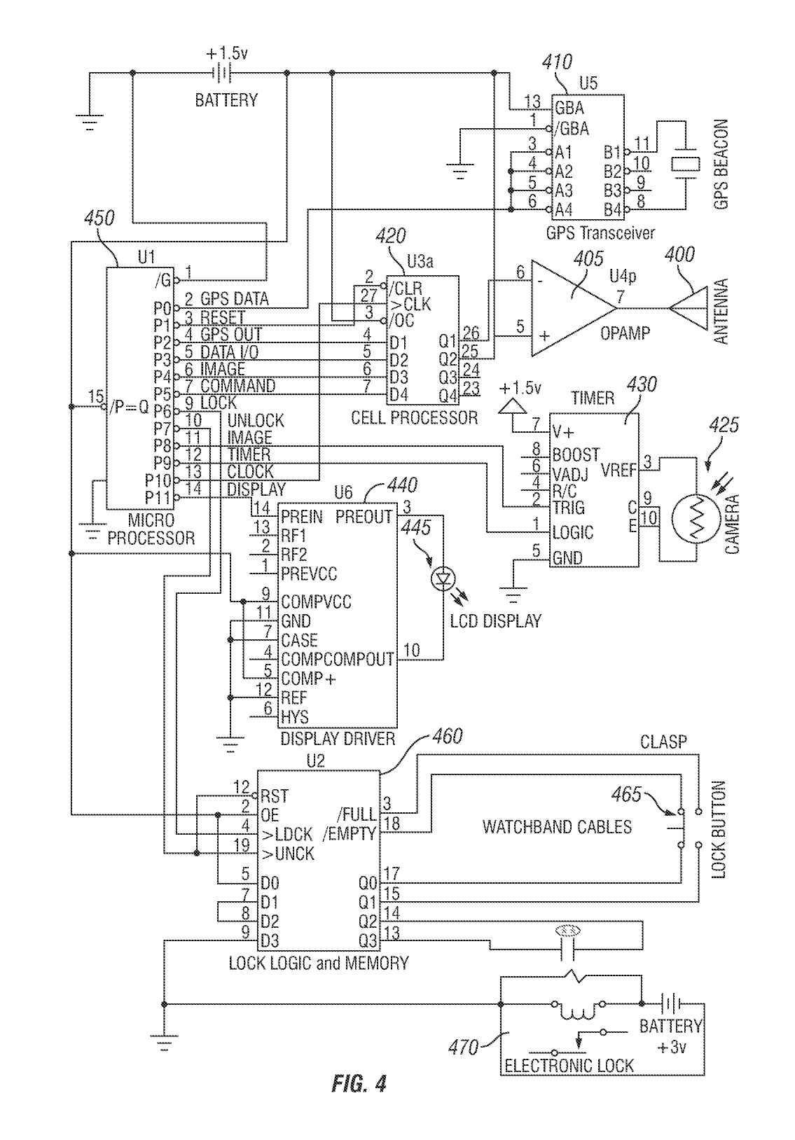

FIG. 4 illustrates an embodiment, showing the different circuitry that can be used for the watch. The watch may have an antenna 400, driven by an amplifier 405. There can also be a GPS transceiver 410 which receives the GPS information. A cell processor 420 can allow the different communication over the cellular network. A camera 425 can also be activated as described herein, and can take pictures as necessary. The camera may be driven by a timer 430 to automatically cause the camera to take pictures at various intervals. A display driver IC 440 drives a display 445. The processor 450 may carry out the various housekeeping operations.

A lock processor 460 can be a generalized IC that monitors a switch 465 associated with the lock mechanism. The switch may be in one position as shown when locked, and may be in the other position when unlocked. The IC detects the lock/unlock, to create a warning when in when the device is tampered with. In addition, the lock can be electrically actuated at 470 by a relay based on a command sent over the cellular system, as previously described.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other functions may be controllable from this watch.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A tracking device, comprising:
a wrist mounted part, having a wristband and a clasp which holds the wristband on to the wrist of a user, and having a housing, and electronics in said housing, said electronics including a position detecting part which detects the position of a user who is wearing said wrist mounted part, a cellular transceiving part which communicates information including said information via the cellular network, and a processor that automatically produces an alarm based on a position of the user when in a monitoring mode.

2. A device as in claim 1, further comprising a camera within said package, said camera automatically actuated when said alarm is produced.

3. A device as in claim 1, wherein said position detecting part detects position by both of GPS detection and also by triangulating between cellular transmitters.

4. A device as in claim 1, wherein said processor controls communication over said cellular transmitting part, with a remote node that monitors an operation of said wrist mounted part.

5. A device as in claim 4, wherein said processor accepts commands from said remote node.

6. A device as in claim 4, wherein said commands include a first command which queries a position of a user of the watch, and sends back a message indicating a current position.

7. A device as in claim 4, wherein said commands include an unlock command which unlocks said clasp, and a lock command that locks said clasp.

8. A device as in claim 1 wherein said cellular transceiving part communicates said information via G3 cellular internet connectivity.

9. A method of tracking a user's movements, comprising:
holding an electronic device on to a wrist of a user using a clasp that holds a wristband;
in said electronic device, detecting a position of a user who is wearing said wrist mounted part;
communicating information from said device including information indicative of said position, via the cellular network; and
automatically produces an alarm based on a position of the user when operating in a monitoring mode.

10. A method as in claim 9, wherein said position detecting part detects position by both of GPS detection and also by triangulating between cellular transmitters.

11. A method as in claim 9, wherein said processor controls communication over said cellular transmitting part, with a remote node that monitors an operation of said wrist mounted part.

12. A method as in claim 11, further comprising commands from said remote node and taking an action based on the accepted commands.

13. A method as in claim 12, wherein said commands include a first command which queries a position of a user of the watch, and sends back a message indicating a current position.

14. A method as in claim 13, wherein said commands include at least one command that only operates during a monitoring mode.

15. A method as in claim 9, further comprising a camera within said package, and further comprising using said camera to automatically take pictures when said alarm is produced.

16. A device as in claim 9 wherein said cellular transceiving part communicates said information via G3 cellular internet connectivity.
